(19) United States
(12) Patent Application Publication
(10) Pub. No.: US 2016/0118846 A1
(43) Pub. Date: Apr. 28, 2016

(54) Isolated-Type Hybrid Solar Photovoltaic System and Switching Control Method

(71) Applicants: BIN-JUINE HUANG, Taipei (TW); PO-CHIEN HSU, Taipei (TW); JONG-FU YEH, Taipei (TW)

(72) Inventors: BIN-JUINE HUANG, Taipei (TW); PO-CHIEN HSU, Taipei (TW); JONG-FU YEH, Taipei (TW)

(21) Appl. No.: 14/525,234

(22) Filed: Oct. 28, 2014

(51) Int. Cl. H02J 7/35; H01M 10/46; H02J 7/00; H02S 40/38

(52) U.S. Cl. CPC H02J 7/35; H02S 40/38; H01M 10/465; H02J 7/007; H02J 7/0021

(57) ABSTRACT

A isolated-type hybrid solar photovoltaic system contains: a solar cell having a peak power value of the solar cell, a battery having a power capacity and a discharge depth, a controller, at least one independent inverter, at least one relay, at least one AC load, at least one load measuring element, at least one load transmission wire, a AC grid power, and a microprocessor. The controller is electrically connected with the solar cell, the battery, the microprocessor, and the at least one independent inverter. The at least one relay has a first connecting point electrically connected with the at least one AC load and has two second connecting points electrically connected with the AC grid power and AC output end of the at least one independent inverter. The at least one relay further has a driving connection point electrically connected with an output end of the microprocessor.

### FIELD OF THE INVENTION

The present invention relates to an isolated-type hybrid solar photovoltaic (PV) system which has a switching control method to effectively supply electric power either from grid or from stand-alone solar PV system.

### BACKGROUND OF THE INVENTION

With reference to FIG. 1, a conventional stand-alone solar power generator does not connect with a grid and contains a battery 2, a controller 3 for controlling charge/discharge of battery, and a solar panel 1, such that in a cloudy day or a rainy day, the battery 2 supplies power to an AC load 5 via an inverter 41.

Referring to FIG. 2, a conventional grid-tied solar power generator contains a battery 2, a controller 3 for controlling a power charge/discharge of battery 2, and a solar panel 1 for generating power, wherein the battery 2 discharges power to the AC load 5 through a grid-tied inverter 42, and insufficient power supply is supplemented by inputting AC mains electricity via the grid 6. The grid-tied inverter 42 can also output AC power into the grid if there is excess power from the solar power generator. The aforementioned stand-alone and grid-tied solar generators can be combined together to from a mixed-type solar power generator. As shown in FIG. 3, a solar power generator contains a solar panel 1, at least one relay for shifting the solar power generator to become a grid-tied system (without battery) or a stand-alone system (with battery). When the grid power is available, a first relay A (71) is switched to the grid-tied system, and a second relay B(72) is switched to the grid-tied inverter 42, such that the solar panel 1 supplies the power to an emergency load 50 (such as an emergency lighting device on an exit) through the grid-tied inverter 42. Meanwhile, the grid 6 supplies supplementary power to the load or accepts excess power of solar panel. In case the grid is not available, the grid-tied system detects an islanding phenomenon, and the second relay B(72) is switched to the stand-alone system (with battery charge/discharge) to supply power continuously, and the first relay A(71) is switched to the stand-alone inverter (41) so that the solar power panel continues to supply power to the emergency load 50. However, only in a failure of the mains electricity, the battery 2 supplies the power after shifting the system to supply power from the solar cell 1 to the-battery 2. In addition, the first relay A(71) is usually shifted to the mode so that the solar cell 1 charges the power to the battery 2 via the controller 3.

Nevertheless, an inverter of the hybrid solar power generator has to output alternative current, when AC grid outputs alternative current, thus increasing installation complication and cost.

Referring to FIG. 4, a conventional isolated-type hybrid solar photovoltaic system isolates mains electricity (grid-tied type) and solar power solar power) (stand-alone type) by ways of a relay C (73) to supply power in a grid mode and a PV mode. For example, when solar power is enough to supply the power, the isolated-type hybrid solar photovoltaic system is shifted to the PV mode so that the sun supplies the power (by matching with a storage power) without supplying the power back to a grid. When a solar PV power generated and the battery storage energy does not supply the power sufficiently, the isolated-type hybrid solar photovoltaic system is shifted to the grid mode so that AC grid power 6 supplies the power directly. It is to be noted that the isolated-type hybrid solar photovoltaic system does not supply solar power back to the grid, and when power supply is not sufficient, an inverter does not parallelly connect with the grid to supply the power to a load, thus supplying the power in the grid mode and the PV mode independently. However, the conventional isolated-type hybrid solar photovoltaic system influences operating efficiency, reliability, and a lifespan of the-battery. A cycle time (means charging from a lowest voltage to a highest voltage and then discharging to the lowest voltage) of the battery is limited, such as 3000 times to lithium battery or 700 times for the cycle time of lead-acid battery. Furthermore, a switch of the isolated-type hybrid solar photovoltaic system influences cycle time of power charge/discharge of the battery, switching frequencies of grid-tied type and stand-alone type, and using efficiency of solar energy. Therefore, the less the cycle time of the power charge/discharge of the battery is decreased, the longer lifespan of the battery is enhanced. Preferably, the system cost is reduced. Furthermore, when switching times of a relay C(73) is reduced, the lifespan of the relay C(73) is prolonged, thus increasing reliability of the system.

The present invention has arisen to mitigate and/or obviate the afore-described disadvantages.

### SUMMARY OF THE INVENTION

The primary objective of the present invention is to provide an isolated-type hybrid solar photovoltaic system which enhances lifespan of a battery and a relay and reduces cost.

To obtain the above objective, an isolated-type hybrid solar photovoltaic system provided by the present invention contains:

a solar cell having a peak power value Eₚᵥₘₐₓ;

a battery having a power capacity C_{bat} and a discharge depth DOD;

a controller;

at least one independent inverter;

at least one relay;

at least one AC load;

at least one load measuring element;

at least one load transmission wire;

a AC grid power;

a microprocessor.

The controller is electrically connected with the solar cell, the battery, the microprocessor, and the at least one independent inverter to control a power charge and a power discharge of the battery.

The at least one relay has a first connecting point electrically connected with the at least one AC load, the at least one relay also has two second connecting points electrically connected with the AC grid power and AC output end of the at least one independent inverter; and the at least one relay further has a driving connection point electrically connected with an output end of the microprocessor, such that the microprocessor outputs diving power to the at least one relay to shift the system to a grid mode or an independent mode, thus supplying power to a AC load or plural AC loads.

### BRIEF DESCRIPTION OF THE DRAWINGS

FIG. 1 is a conventional stand-alone type solar power generator.

FIG. 2 is a conventional grid-tied type solar power generator.

FIG. 3 is a conventional hybrid solar power generator.

FIG. 4 is a diagram showing the assembly of an isolated-type hybrid solar photovoltaic system according to a preferred embodiment of the present invention.

FIG. 5 is a diagram showing a change relationship of an adjustable parameter A_{f} according to the preferred embodiment of the present invention.

FIG. 6 is a diagram showing an analysis of a trapezoidal function A_{f} according to the preferred embodiment of the present invention.

FIG. 7 is a diagram showing an analysis of a loss of a solar energy generation as using the trapezoidal function A_{f} according to the preferred embodiment of the present invention.

FIG. 8 is a diagram showing an analysis of a fixed function A_{f} according to the preferred embodiment of the present invention.

FIG. 9 is a diagram showing an analysis of a loss of a solar energy generation as using the fixed function A_{f} according to the preferred embodiment of the present invention.

FIG. 10 is a diagram showing the operation of the isolated-type hybrid solar photovoltaic system according to the preferred embodiment of the present invention.

FIG. 11 is a diagram showing the application of the isolated-type hybrid solar photovoltaic system according to the preferred embodiment of the present invention.

FIG. 12 is another diagram showing the application of the isolated-type hybrid solar photovoltaic system according to the preferred embodiment of the present invention.

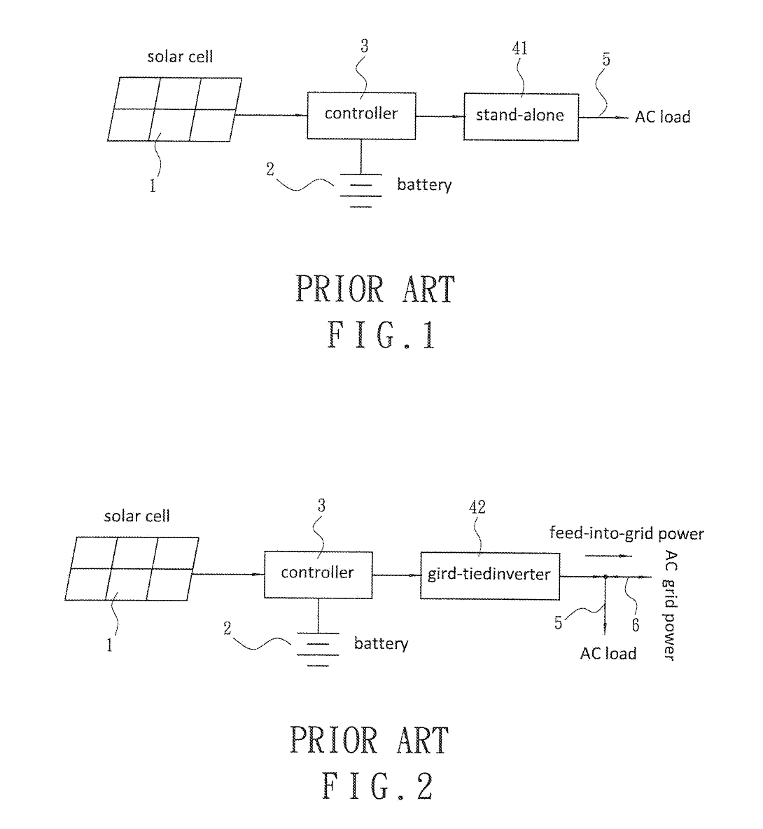

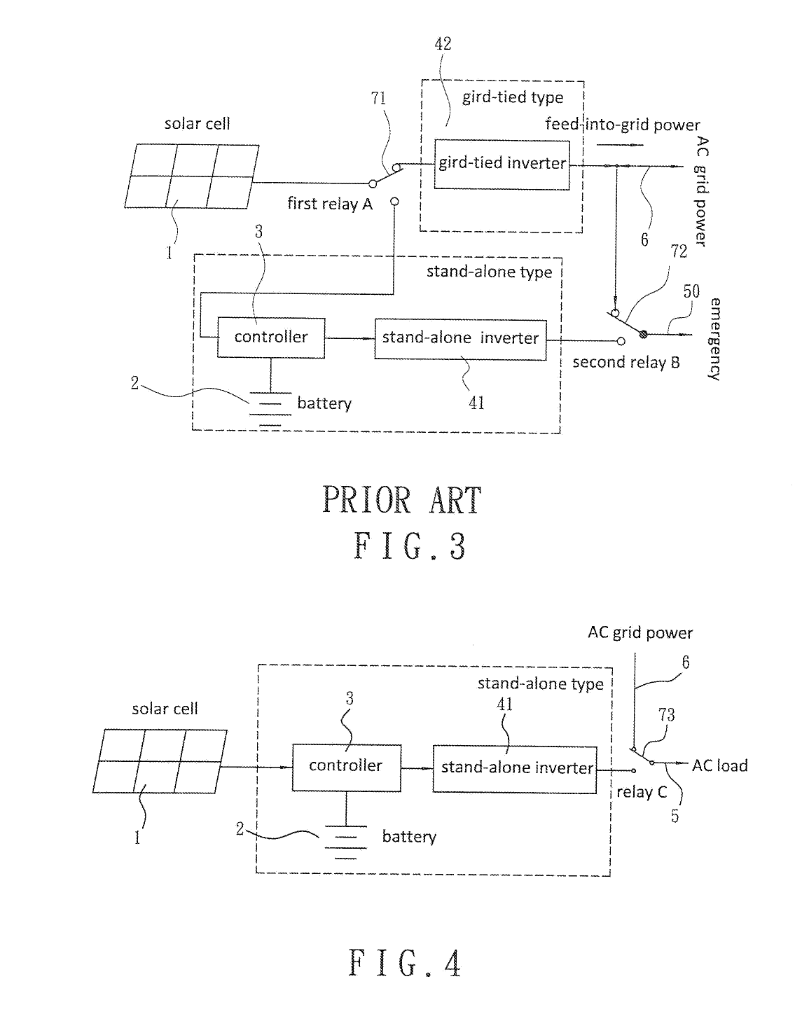

### DETAILED DESCRIPTION OF THE PREFERRED EMBODIMENTS

An isolated-type hybrid solar photovoltaic system according to a preferred embodiment of the present invention comprises a battery for buffing energy, wherein the battery keeps charging power and discharging power continuously, and when a solar cell generates power insufficiently, the isolated-type hybrid solar photovoltaic system is shifted to a grid mode so that main electricity supplies the power to a load, and the solar cell charges the battery, thereafter the system is shifted back to an independent mode.

After shifting to the grip mode, the battery cumulates a cumulative charging amount E_{B}, and E_{B} is set as a control parameter, when E_{B} reaches to a certain amount (i.e., a critical charging amount, symbolized as S_{B}), its represents power capacity in the battery is enough, so the system is shifted to the independent mode. Preferably, S_{B} influences switching times of a relay C(73), a charging and discharging cycle time of the battery 2, and solar using efficiency.

Theoretically speaking, a lower S_{B} reduces operation time of the system in the grid mode (supplying power by using grid), and after shifting the system back to the independent mode (supplying the power by sun), the solar use efficiency is enhanced. However, in low solar radiation amount or high load, the battery discharges power to the lowest voltage point, increases the cycle time, and reduces the lifespan of the battery. The cycle time of the battery 2 and on/off times of the relay C(83) are influenced by the solar power capacity, a load electricity, a capacity of the battery, and a discharge depth of the battery, and their critical charging amount S_{B} is calculated by Formula (1) as follows:

S_{B}=DOD×C_{bat}×A_{f} Formula (1)

DOD represents a discharge depth of the battery, C_{bat} denotes the capacity of the battery; A_{f} implies an adjustable parameter 0 to 1 which is fixed value or is changed based operation state. A variable of solar power margin is e_{B}, and the variable of the adjustable parameter is calculated by Formula (2) as follows:

e_{B}=(Eₚᵥ−E_{L})/Eₚᵥₘₐₓ Formula (2)

Eₚᵥ means a solar power, E_{L} represents AC load power, Eₚᵥₘₐₓ implies a peak power value of the solar cell, and e_{B} implies the operation state, wherein a positive value of e_{B} represents sufficient power capacity of sunlight or low load of power consumption, and a negative value of e_{B} denotes insufficient power capacity of the sunlight or a high load of power consumption.

The adjustable parameter A_{f} of Formula (1) relates to the operation state e_{B}, i.e., the critical charging amount S_{B} is changed with e_{B}. For instance, when the variable of the solar power margin e_{B} is small, the solar power capacity is small or when the load of power consumption is high, it represents insufficient solar power capacity. Accordingly, S_{B} is set at a high value so that the system operates at long time to charge more power toward the battery, hence after the system is shifted to the independent mode, the battery is not vent. When the variable of the solar power margin e_{B} is large, the solar power capacity is large or when the load of power consumption is low, it represents sufficient solar power capacity. Accordingly, S_{B} is set at a low value so that the system operates is shifted to the independent mode to use the solar energy quickly, and a relationship between A_{f} and e_{B} is defined as plural functions of Formula (3) as follows:

A_{f}=K₀+K₁e_{B}+K₂e_{B}²+K₃e_{B}³+ Formula (2)

wherein K₀, K₁, K, and K₃ are acquired based on system analysis or operational experience.

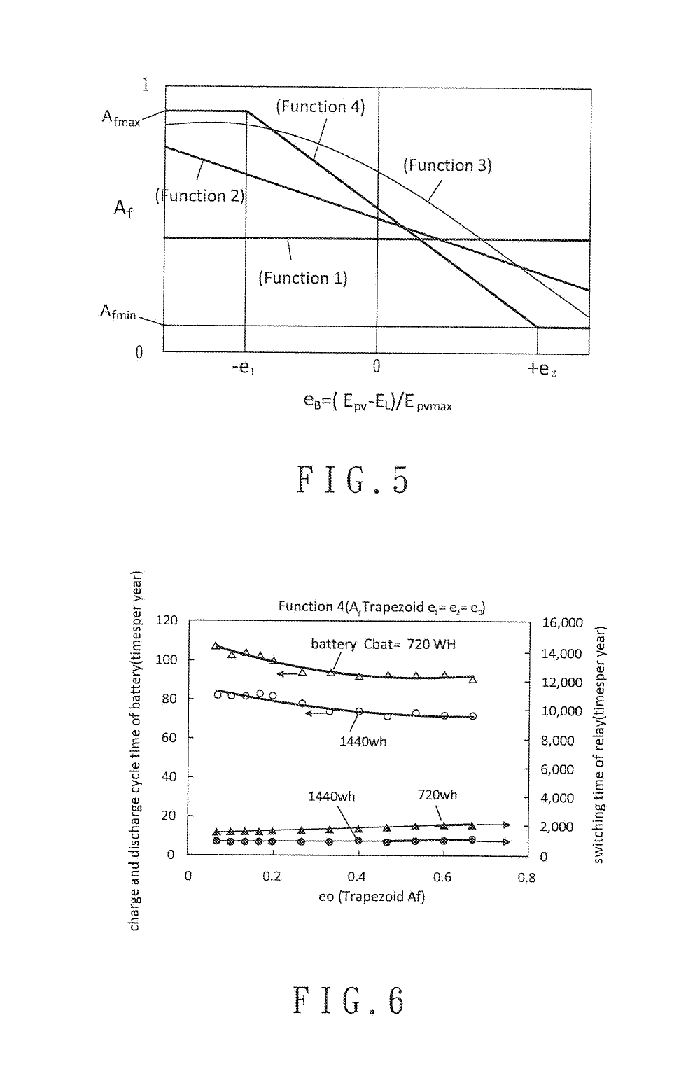

As shown in FIG. 5, a function relationship between A_{f} and e_{B} is listed, wherein (Function 1) represents A_{f} is a constant, i.e., K₁=K₂=K₃= . . . =0; (Function 2) denotes A_{f} variances linearly with e_{B}, i.e., K₂=K₃=...=0; (Function 3) implies A_{f} variances curvedly with e_{B}. Furthermore, a changing relationship between A_{f} and e_{B} is set as a trapezoidal function (Function 4).

When the solar radiation is large, the load is small and the battery is full, the solar cell cannot generate power wholly, thus losing the solar power capacity. Therefore, a functional relationship of A_{f} influences a loss of the solar energy generation. The critical charging amount S_{B} is obtained according to function A_{f} of FIG. 5, such that the charging and discharge cycle time of the battery and the on/off times of the relay are reduced, and the loss of the solar energy generation is decreased.

The operational efficiency of the system of the present invention is simulated by a computer on basis of the functional relationship between A_{f} and e_{B} of FIG. 5. In simulation, an installing capacity of the solar cell (1) is set to 1,500 watts peak (kWp), AC load 5 is a frequency heating and cooling machine (at 200 to 900 power consumption) which runs 11 hours (from AM 8:00 to PM 9:00) every day, consumes power 9.8 degrees (kWh) in summer (from May to September) or 6.5 degrees (kWh) in October to April. By means of energy balance principle, two capacities (i.e., 720 Wh and 1,440 Wh) of the battery are calculated after inputting annual Taipei weather data.

FIG. 6 shows a trapezoidal function A_{f}, i.e., the (Function 4), wherein A_{fmin} is 0.05, A_{fmax} is 0.95, and two trapezoidal values e₁ and e₂ are symmetrical to zero (i.e., e₁=e₂=eₒ), a calculating result is obtained at different slopes (different eₒ). As illustrated in FIG. 6, eₒ is set within 0.05 to 0.70, when the capacity of the battery is 720 Wh, an annual cycle time of the battery is less than 110, and a switching time of the relay C(73) is less than 2,110; and when the capacity of the battery is 1,440 Wh, the annual cycle time of the battery is less than 90, and the switching time of the relay C(73) is less than 1,100.

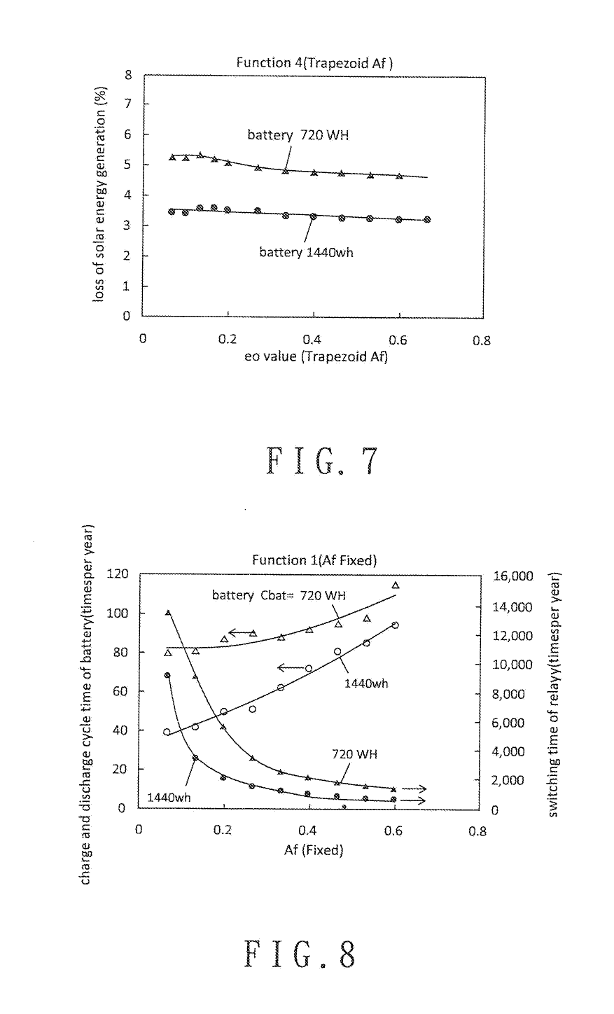

FIG. 7 shows a trapezoidal function A_{f}, i.e., the (Function 4), wherein when eₒ is set within 0.05 to 0.70, the loss of the solar energy generation (including linear loss 2% and a loss of inverter 10%) is shown. For example, when the capacity of the battery is 720 Wh, the loss of the solar energy generation is less than 5.4%, and when the capacity of the battery is 1,440 Wh, the loss of the solar energy generation is less than 3.6%.

Referring to FIGS. 6 and 7, the cycle time of the battery, the switching time of the relay and the loss of the solar energy generation change gently, and the system operates stably, thus enhancing the lifespan of the battery, operating efficiency and reliability of the system.

It is to be noted that when eₒ is set at a large value, it is close to a linear function (Function 2), and the trapezoidal function (Function 4) is actually close to a curve function (Function 3).

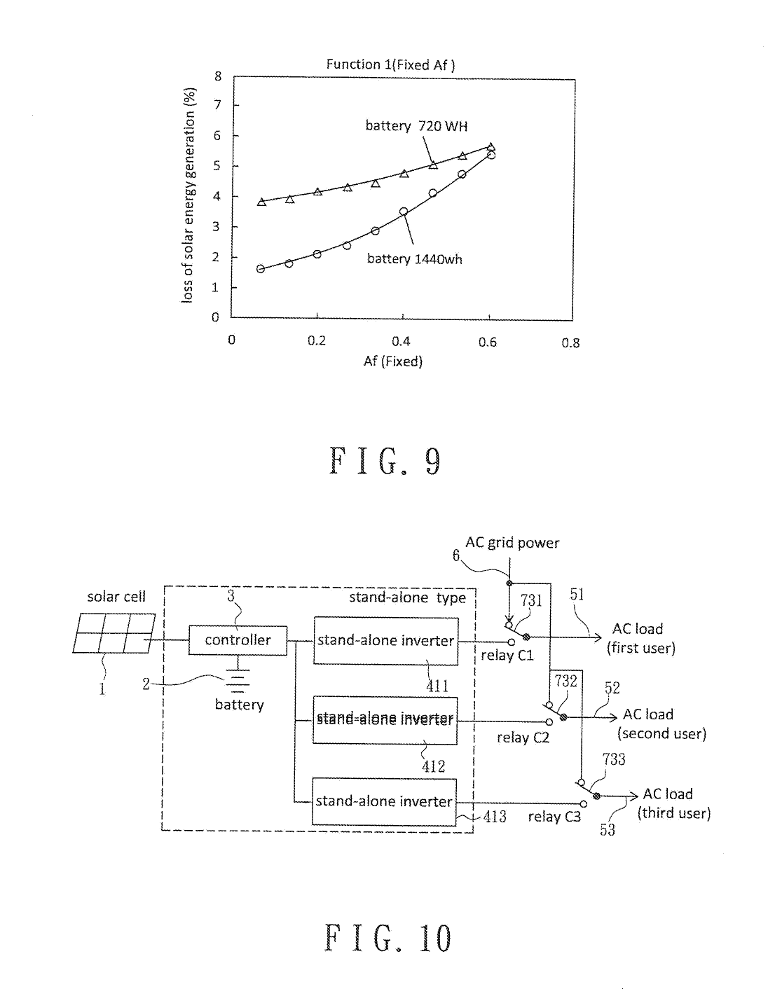

When A_{f} is a fixed value (Function 1), the simulation analysis result is shown in FIGS. 8 and 9. For example, as illustrated in FIG. 8, when A_{f} is set within 0.05 to 0.60 and the capacity of the battery is 720 Wh, an annual cycle time of the battery is less than 115, and an switching time of the relay C(73) is close to 13,000; and when the capacity of the battery is 1,440Wh, the annual cycle time of the battery is less than 94, and the switching time of the relay C(73) is close to 9,000, so a preferable A_{f} is within 0.3 to 0.6.

As shown in FIG. 9, when A_{f} is set within 0.05 to 0.60 and the capacity of the battery is 720 Wh, the loss of the solar energy generation is less than 5.7%, and when the capacity of the battery is 1,440 Wh, the loss of the solar energy generation is less than 5.4%.

It is to be noted that when installation location and the load change, the simulation analysis result changes accordingly. The system is shifted by adjusting the function A_{f} and is simulated by the computer on basis of a quantity of the solar cell, the capacity of the battery, the load, a loading change, and solar radiation in different areas.

With reference to FIG. 10, the isolated-type hybrid solar photovoltaic system comprises plural independent converters 411, 412, 413 and plural relies C1(731), C2(732), C3(733) to supply the power to plural users, thus forming mutual power supply system to balance the load change and to lower installation cost of the battery.

To total a power consumption of AC load of all users, the system is shifted based on using requirement.

Referring to FIG. 10, the system is applied to a loading management of individual user. For instance, when the system operates in the independent mode, the power Eₚᵥ of the solar cell and AC load power of each user are monitored and managed. In other words, the AC load is classified to high load, medium load and low load or to first priority supply, second priority supply, and third priority supply. For example, when the solar cell generates the power at low solar power capacity (determined according to e_{B}), the system is shifted to the grid mode to supply the power toward a high load user, a medium load user, and a low load user or toward a first priority user, a second priority user, and a third priority user in turn, such that a discharge capacity of the battery is reduced, and the operation time of the system in the independent mode is prolonged.

Referring to FIG. 4, the system is controlled and shifted by a microprocessor. As shown in FIG. 11, the relay C(73) is a double throw type and has a first connecting point electrically connected with the AC load 5 and has two second connecting points electrically connected with the AC grid power 6 and AC output end of an independent 41; and the relay C(73) has a driving connection point electrically connected with an output end of the microprocessor 9 via a power transmission wire; the microprocessor 9 outputs diving power to the relay C(73) through the power transmission wire 90 to shift the system.

In the grid mode, the solar cell charges the power to the battery, a first power generating signal of the solar cell is transmitted to the microprocessor 9 from a first power measuring element 81 of the solar cell via a signal transmission wire 91. A power charging signal of the battery is transmitted to the microprocessor 9 from a second power measuring element 82 of the battery via a signal measuring transmission wire 92. An AC loading signal is transmitted to the microprocessor 9 from a load measuring element 83 through a load transmission wire 93.

After the microprocessor 9 receives the power generation of the solar cell, a charging amount of the battery, and a load consumption signal, the variable of the solar power margin e_{B} is calculated by using the Formula (2), the adjustable function A_{f} is obtained after calculating the (Function 1), the (Function 2), the (Function 3), and the (Function 1). The critical charging amount S_{B} is calculated after setting into Formula (2), and the microprocessor 9 controls the system. When the system is shifted to the grid mode, the cumulative charging amount E_{B} is measured, and as reaching to the critical charging amount S_{B}, the microprocessor 9 outputs the driving power to the relay C(73) through the power transmission wire 90 so that the system is shifted to the independent mode.

With reference to FIG. 11, the microprocessor 9, a controller 3, the relay C(73), the first power measuring element 81 of the solar cell, the second power measuring element 82 of the battery, the load measuring element 83, the signal transmission wire 91, the signal measuring transmission wire 92, and the load transmission wire 93 are connected together to form a main control unit (MCU) 101 which is electrically connected with the solar cell 1, the battery 2, the independent 41, the AC grid power 6, and the AC load 5. In other words, the system is comprised of the solar cell 1, the battery 2, the independent inverter 41, and the main control unit (MCU) 101.

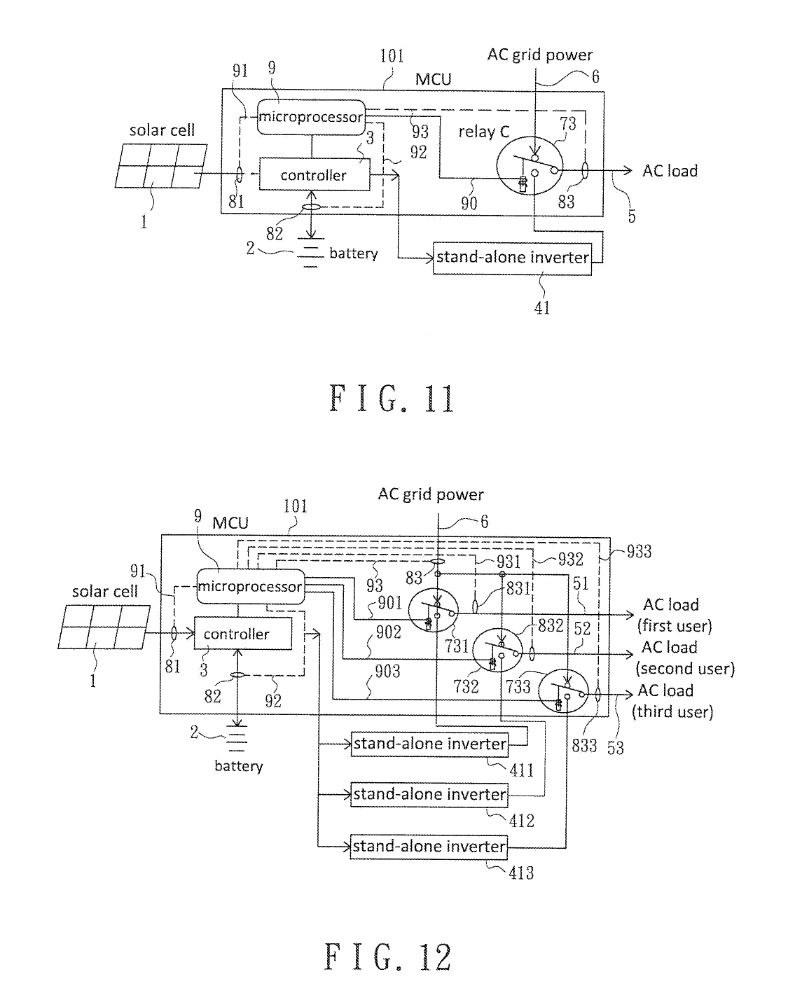

Referring to FIG. 10, the system comprises a plurality of relays C1(731), C2(732), C3(733) to measure the power efficiency of the solar cell, the power capacity of the battery, a charging and discharging power of the battery, and a power consumption of a total load, and the microprocessor controls a switch of the plurality of relays C1(731), C2(732), C3(733). As shown in FIG. 12, the power efficiency of the solar cell is transmitted to the microprocessor 9 from the first power measuring element 81 through the signal transmission wire 91; the power capacity of the battery is transmitted to the microprocessor 9 from the second power measuring element 82 through the signal measuring transmission wire 92; the power consumption of the total load is transmitted to the microprocessor 9 from a first load measuring element 831, a second load measuring elements 832, and a third load measuring elements 833 via a first load transmission wire 931, a second load transmission wire 932, and a third load transmission wire 933.

As shown in FIGS. 10 and 12, the system operates in the independent mode, and the microprocessor 9 receives the power generation of the solar cell, the power capacity of the battery, and the load electricity of each user. To total a power consumption of all users, the variable of the solar power margin e_{B} is calculated by the Formula (2), and the adjustable parameter A_{f} is calculated by using Formula (3) or the (Function 1), the (Function 2), the (Function 3), and the (Function 4). The critical charging amount S_{B} is calculated after setting into Formula (1), and the microprocessor 9 controls the system. When the system is shifted to the grid mode, the cumulative charging amount (E_{B}) is measured, and as reaching to the critical charging amount S_{B}, the microprocessor 9 outputs the driving power to a first relay C1(731), a second relay C2(732), and a third relay C3(733) through a first power transmission wire 901, a second power transmission wire 902, and a third power transmission wire 903 so that the system is shifted to the independent mode.

As illustrated in FIGS. 10 and 12, AC loads of all users have the first load measuring element 831, the second load measuring elements 832, and the third load measuring elements 833; and the system monitors and manages the power of of the solar cell and the AC load of each user in the independent mode. In other words, the AC load is classified to high load, medium load and low load or to first priority supply, second priority supply, and third priority supply. For example, when the solar cell generates the power at low power capacity (determined according to e_{B}), the system is shifted to the grid mode to supply the power toward a high load user, a medium load user, and a low load user or toward a first priority user, a second priority user, and a third priority user in turn, such that a discharge capacity of the battery is reduced, and the operation time of the system in the independent mode is prolonged.

With reference to FIG. 12, the microprocessor 9, the controller 3, the first relay C1(731), the second relay C2(732), the third relay C3(733), the first power measuring element 81 of the solar cell, the second power measuring element 82 of the battery, the load measuring element 83, the first load measuring element 831, the second load measuring elements 832, the third load measuring elements 833, the signal transmission wire 91, the signal measuring transmission wire 92, the load transmission wire 93, the first load transmission wire 931, the second load transmission wire 932, and the third load transmission wire 933 are connected together to form the main control unit (MCU) 101 which is electrically connected with the solar cell 1, the battery 2, the plural stand-alone inverters 411, 412, 413, the AC grid power 6, and the AC load 5. In other words, the system is comprised of the solar cell 1, the battery 2, the plural stand-alone inverters 411, 412, 413, and the main control unit (MCU) 101.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. An isolated-type hybrid solar photovoltaic system comprising:
a solar cell having a peak power value Eₚᵥₘₐₓ;
a battery having a power capacity C_{bat} and a discharge depth DOD;
a controller;
at least one independent;
at least one relay;
at least one AC load;
at least one load measuring element;
at least one load transmission wire;
a AC grid power;
a microprocessor;
wherein the controller is electrically connected with the solar cell, the battery, the microprocessor, and the at least one independent to control a power charge and a power discharge of the battery;
wherein the at least one relay has a first connecting point electrically connected with the at least one AC load, the at least one relay also has two second connecting points electrically connected with the AC grid power and AC output end of the at least one independent inverter; and the at least one relay further has a driving connection point electrically connected with an output end of the microprocessor, such that the microprocessor outputs diving power to the at least one relay to shift the system to a grid mode or an independent mode, thus supplying power to a user or plural users.

2. The isolated-type hybrid solar photovoltaic system as claimed in claim 1 further comprising a first power measuring element for measuring the solar power capacity of the solar cell, a second power measuring element for measuring a power charge and the power discharge of the battery, and a load measuring element for measuring AC load power; wherein when a system operates in the grid mode, the solar power capacity Eₚᵥ, of the solar cell, the power charge and the power discharge E _{bat} of the storage batter, and the AC load power consumption E_{L} are inputted into the microprocessor to calculate variable of solar power margin e_{B}=(Eₚᵥ−E_{L})/Eₚᵥₘₐₓ, an adjustable parameter A_{f} is calculated by using linear or curve change relationship, and a critical charging amount is acquired by calculating S_{B}=DOD×C_{bat}×A_{f}, such that the at least one relay is shifted; and when the system is shifted to the grid mode, a cumulative charging amount E_{B} is measured, wherein when the cumulative charging amount E_{B} reaches S_{B}, the system is shifted to the independent mode.

3. The isolated-type hybrid solar photovoltaic system as claimed in claim 2, wherein the adjustable parameter A_{f} is a fixed value.

4. The isolated-type hybrid solar photovoltaic system as claimed in claim 2, wherein a changing relationship between A_{f} and e_{B} is set as a trapezoidal function.

5. The isolated-type hybrid solar photovoltaic system as claimed in claim 1, wherein when the system supplies power to the plural users, the system comprises a first power measuring element for measuring the solar power capacity of the solar cell, a second power measuring element for measuring a power charge and the power discharge of the battery, and a load measuring element for measuring AC load power; wherein when the system operates in the grid mode, the solar power capacity of of the solar cell, the power charge and the power discharge E_{bat} of the storage batter, and the AC load power consumption E_{L} are inputted into the microprocessor to calculate variable of solar power margin e_{B}=(Eₚᵥ−E_{L})/Eₚᵥₘₐₓ, an adjustable parameter A_{f} is calculated by using linear or curve change relationship, and a critical charging amount is acquired by calculating S_{B}=DOD×C_{bat}×A_{f}, such that the at least one relay is shifted; and when the system is shifted to the grid mode, a cumulative charging amount E_{B} is measured, wherein when the cumulative charging amount E_{B} reaches S_{B}, the system is shifted to the independent mode.

6. The isolated-type hybrid solar photovoltaic system as claimed in claim 5, wherein the adjustable parameter A_{f} is a fixed value.

7. The isolated-type hybrid solar photovoltaic system as claimed in claim 5, wherein a changing relationship between A_{f} and e_{B} is set as a trapezoidal function.

8. The isolated-type hybrid solar photovoltaic system as claimed in claim 1, wherein when the system supplies power to the plural users, the system comprises a first power measuring element for measuring the solar power capacity of the solar cell and a second power measuring element for measuring a power charge and the power discharge of the battery; and each user has a first load measuring element, a second load measuring elements, and a third load measuring elements to measure AC load power; the system monitors and manages the AC load of each user in the independent mode, and each user is shifted to the independent mode to prolong operation time.

9. The isolated-type hybrid solar photovoltaic system as claimed in claim 1, wherein the microprocessor, the controller, the at least one relay, the first power measuring element of the solar cell, the second power measuring element of the battery, at least one load measuring element, the signal transmission wire, the signal measuring transmission wire, at least one load measuring transmission wire are connected together to form a main control unit which is electrically connected with the solar cell, the battery, and the at least one independent inverter to generate a modular system, and the modular system comprises the solar cell, the battery, the at least one independent inverter, and the main control unit.
